(19) United States
(12) Patent Application Publication
(10) Pub. No.: US 2020/0339788 A1
(43) Pub. Date: Oct. 29, 2020

(54) Solid Resin Plasticizers for Thermoplastic Vulcanizates

(71) Applicant: ExxonMobil Chemical Patents Inc., Baytown, TX (US)

(72) Inventors: Wanli Wang, Katy, TX (US); James P. Stokes, Katy, TX (US); Michael B. Rodgers, Cedar Park, TX (US); Declan N. Whelan, Rugby (GB); Michael J. Goncy, Mont Belvieu, TX (US)

(21) Appl. No.: 16/855,005

(22) Filed: Apr. 22, 2020

Related U.S. Application Data
(60) Provisional application No. 62/837,402, filed on Apr. 23, 2019.

(51) Int. Cl. C08L 23/06; C08K 5/00; C08K 5/01; C08L 91/06; C08L 23/08; C08L 23/12; C08L 23/22; C08L 21/00; C08K 3/013

(52) U.S. Cl. CPC C08L 23/06; C08L 2310/00; C08K 5/0025; C08K 5/01; C08L 91/06; C08L 23/0815; C08L 23/12; C08L 23/22; C08L 21/00; C08K 3/013; C08L 2203/02; C08L 2205/035; C08L 2207/04; C08L 2207/322; C08K 5/0016

(57) ABSTRACT

Thermoplastic vulcanizates (TPVs) may comprise a vulcanizable elastomer rubber, a thermoplastic polymer, and a plasticizer, wherein the plasticizer comprises a solid resin. Methods include introducing to a blender a masterbatch comprising a first thermoplastic polymer and a curative, a vulcanizable elastomer rubber, a second thermoplastic polymer, and 25 parts to 250 parts of a plasticizer by weight of the vulcanizable elastomer rubber. The first and second thermoplastic polymers combined are 20 parts to 250 parts by weight of the vulcanizable elastomer rubber, and the plasticizer comprises a solid resin. The masterbatch, thermoplastic resin, and plasticizer are then dynamically vulcanized in at least a portion of the vulcanizable elastomer rubber to form a thermoplastic vulcanizate.

### CROSS-REFERENCE TO RELATED APPLICATIONS

This application claims priority to U.S. Ser. No. 62/837,402, filed Apr. 23, 2019, herein incorporated by reference.

### FIELD

The present disclosure relates to thermoplastic vulcanizates (“TPVs”), and methods of making TPVs.

### BACKGROUND

TPVs are a class of thermoplastic compositions that include cross-linked elastomer particles finely dispersed in a continuous thermoplastic phase. TPVs combine the elastomer phase's elastomeric properties with the processability of thermoplastics. The production of TPVs may include the process of dynamic vulcanization. During dynamic vulcanization, the elastomer component is selectively crosslinked (otherwise referred to alternatively as curing or vulcanization) during its melt mixing with the molten thermoplastic under intensive shear and mixing conditions within a blend of at least one non-vulcanizing thermoplastic polymer component while at or above the melting point of that thermoplastic. See, for example, U.S. Pat. Nos. 4,130,535; 4,594,390; 6,147,160; 7,622,528; and 7,935,763, the entirety of each of which is incorporated by reference herein.

TPVs may subsequently be extruded, injected, or otherwise molded by conventional plastic processing equipment to press and shape TPVs into useful products. These thermoplastic vulcanizates can be made to be lightweight with good aesthetics and excellent durability, and may be reprocessed at the end of their useful life to produce a new product. For these and other reasons, TPVs are widely used in industrial applications, for example, as auto parts, such as dashboards and bumpers, air ducts, weatherseals, fluid seals, and other under the hood applications; as gears and cogs, wheels, and drive belts for machines; as cases and insulators for electronic devices; as fabric for carpets, clothes, and bedding, and as fillers for pillows and mattresses; and as expansion joints for construction. TPVs are also widely used in consumer goods, being readily processed, capable of coloration as with other plastics, and providing elastic properties that can endow substrate materials, or portions thereof, for instance harder plastics or metals, in multi-component laminates, with a “soft touch” or rebound properties like rubber.

Thermoplastic vulcanizates can be prepared by dynamic vulcanization in BANBURY® mixers (available from HF Mixing Group and others), roll mixers, and other types of shearing, melt processing mixers. Because of the advantages of a continuous process, such materials can be prepared in single screw or multi-screw extruders.

The environment in which thermoplastic vulcanizates are formed and in which vulcanization of the rubber constituent occurs is typically defined by significant shearing forces, heat, and the presence of a variety of additives, including plasticizers that reduce the viscosity of the TPVs. Paraffinic oil is a plasticizer used in SANTOPRENE® TPVs (thermoplastic elastomers, available from ExxonMobil Corp.) and other extrusion grade TPVs. However, many end-use applications for TPVs do not allow oil to be used as a plasticizer, or require reduced oil content of the TPV. Consequently, a replacement or partial replacement for plasticizer oils is needed.

### SUMMARY

The present disclosure describes TPVs and methods for forming TPVs that include solid resin as a plasticizer.

For example, a TPV composition may comprise 100 parts of a vulcanizable elastomer rubber; 20 parts per hundred parts by weight of the rubber (phr) to 250 phr of a thermoplastic polymer; and 25 phr to 250 phr of a plasticizer; wherein the plasticizer comprises a solid plasticizing resin.

In another example, a method may comprise introducing to a blender each of a masterbatch comprising a first thermoplastic polymer and a curative; 100 parts of a vulcanizable elastomer rubber; a second thermoplastic polymer, wherein the first and second thermoplastic polymers combined are 20 parts per hundred parts by weight of the rubber (phr) to 250 phr; 25 phr to 250 phr of a plasticizer, wherein the plasticizer comprises a solid plasticizing resin; and dynamically vulcanizing at least a portion of the vulcanizable elastomer rubber so as to form a thermoplastic vulcanizate.

In yet another example, a method may comprise introducing to a blender each of a masterbatch comprising a first thermoplastic polymer and a curative; 100 parts of a vulcanizable elastomer rubber; a second thermoplastic polymer, wherein the first and second thermoplastic polymers combined are 20 parts per hundred parts by weight of the rubber (phr) to 250 phr; and performing the steps of at least partially dynamically vulcanizing the vulcanizable elastomer rubber; and introducing to the blender 25 phr to 250 phr of a plasticizer, wherein the plasticizer comprises a solid plasticizing resin.

### DETAILED DESCRIPTION

The present disclosure describes TPVs and methods for forming TPVs that include solid resins as plasticizers as a replacement, partial replacement, or addition to the use of oils as plasticizers.

TPVs are formed from elastomers and thermoplastics via a dynamic vulcanization process. To reduce the viscosity of some TPVs, plasticizers may be used. In many grades of TPVs including SANTOPRENE® TPVs, process oils are used as a plasticizer to reduce viscosity. However, some end-use applications for TPVs, for instance food contact uses and medical uses, do not allow the use of oils. In other end-use applications, a reduced oil content may be desired.

Additionally, when blending the components of a TPV, solid components are preferred in order to eliminate the need for an additional liquid feed line, which is expensive, has increased space requirements, and poses material handling difficulties. Further, solid components are more easily handled and more precisely weighed. Consequently, a solid plasticizer that is an alternative to oil is needed.

In the present disclosure, a solid resin is used as a plasticizer in the TPV process. Solid plasticizing resins suitable for use as a plasticizer may include, but are not limited to, wax, paraffinic wax, low molecular weight polypropylene, modified polypropylene, polyisobutylene, or aliphatic hydrocarbon resins such as the ESCOREZ® series (synthetic resin, available from ExxonMobil Corp.). By using a solid plasticizing resin, partial or total replacement of oil in TPV may be realized while maintaining viscosities suitable for extrusion and formation into useful TPV products.

The present subject matter discloses a method for using solid plasticizing resins as plasticizers for TPVs. Such resins are suitable for inclusion in any TPV, but may have particular utility when the end-use application does not permit the use of oil like food contact or medical uses.

### Definitions and Test Methods

As used herein, the term “olefin” refers to a linear, branched, or cyclic compound comprising carbon and hydrogen and having a hydrocarbon chain containing at least one carbon-to-carbon double bond in the structure thereof, where the carbon-to-carbon double bond does not constitute a part of an aromatic ring. The term olefin includes all structural isomeric forms of olefins, unless it is specified to mean a single isomer or the context clearly indicates otherwise.

As used herein, the term “polymer” refers to a compound having two or more of the same or different “mer” units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically.

As used herein, the term “comonomer” refers to the unique mer units in a copolymer.

As used herein, when a polymer or copolymer is referred to as comprising an olefin, the olefin present in such polymer or copolymer is the polymerized form of the olefin. For example, when a copolymer is said to have a “propylene” content of 35 wt. % to 55 wt. %, it is understood that the mer unit in the copolymer is derived from propylene in the polymerization reaction and said derived units are present at 35 wt. % to 55 wt. %, based upon the weight of the copolymer. A copolymer can be terpolymers and the like.

As used herein, a copolymer of propylene and ethylene is “propylene-based” when propylene-based monomers form the plurality of monomers in the copolymer, based on the total weight of the copolymer (propylene-based monomers are present in the copolymer in larger weight than any other single monomer). Similarly, a copolymer of propylene and ethylene is “ethylene-based” when ethylene-based monomers form the plurality of monomers in the copolymer. Propylene-based copolymers will be indicated by naming propylene first (e.g., “propylene-ethylene copolymers” or “propylene-alpha-olefin in copolymers”), and likewise for ethylene-based copolymers (e.g., “ethylene-propylene copolymers” or “ethylene-alpha-olefin copolymers”). A copolymer of propylene and/or ethylene may optionally include one or more additional comonomers.

As used herein, the term “elastomer” refers to any natural or synthetic polymer exhibiting elastomeric properties, and may be used herein synonymously with “rubber.”

The triad tacticity of a polymer is the relative tacticity of a sequence of three adjacent propylene units, a chain consisting of head to tail bonds, expressed as a binary combination of m and r sequences. Triad tacticity is usually expressed as the ratio of the number of units of the specified tacticity to all of the propylene triads in the propylene-alpha-olefin copolymer. The triad tacticity (mm fraction) of a propylene copolymer can be determined from a 13C NMR spectrum of the propylene copolymer. The calculation of the triad tacticity is described in the U.S. Pat. No. 5,504,172, the entire contents of which are incorporated herein by reference.

Differential scanning calorimetric (“DSC”) data was obtained using a Perkin-Elmer DSC 7. About 5 mg to about 10 mg of a sheet of the polymer to be tested was pressed at approximately 200° C. to 230° C., then removed with a punch die and annealed at room temperature (approximately 25° C.) for 48 hours. The samples were then sealed in aluminum sample pans. The DSC data was recorded by first cooling the sample to −50° C. and then gradually heating the sample to 200° C. at a rate of 10° C./minute. The sample was kept at 200° C. for 5 minutes before a second cooling-heating cycle was applied. Both the first and second cycle thermal events were recorded. A peak “melting point” (Tm) is defined as the temperature of the greatest heat absorption within the range of melting of the sample. The “glass transition temperature” (Tg) is defined as the temperature associated with peak loss modulus. Areas under the melting curves were measured and used to determine the heat of fusion and the degree of crystallinity. The percent crystallinity (X %) was calculated using the formula, X %=[area under the curve (Joules/gram)/B(Joules/gram)]*100, where B is the heat of fusion for the homopolymer of the major monomer component. These values for B were found from the Polymer Handbook, Fourth Edition, published by John Wiley and Sons, New York 1999. A value of 189 J/g (B) was used as the heat of fusion for 100% crystalline polypropylene. The melting temperature was measured and reported during the second heating cycle (or second melt).

Density of a resin is measured by ASTM D1505-18 at 25° C.

Melt index (MI) is measured by ASTM D1238-13 at 190° C. and 2.16 kg weight for ethylene polymers and ethylene-based copolymers, and at 230° C. and 2.16 kg weight for propylene polymers and propylene-based copolymers.

As used herein, “hardness” is hardness provided as a Shore D value at 23° C. in accordance with the method as described in ISO 868:2003.

Kinematic viscosities at 40° C. and at 100° C., and viscosity indices are measured in accordance with ASTM D445-18.

As used herein, “LCR” is a measurement of viscosity in Pa-sec at 1200 sec⁻¹ shear rate using a lab capillary rheometer from Dynisco, per the method described in ASTM D3835-16.

The aromatic content of process oils is measured by ASTM D2007-11.

As used herein, “ESR” is a measure of the surface smoothness of the TPV, where lower numbers indicate a smoother surface. The ESR was measured using a surfanalyzer (surface analysis system, available from Mahr Federal) in accordance with the manufacturer's instructions.

As used herein, “tensile M100” is the modulus of the material given in mPa, and the M100 test indicates resistance to strain at 100% extension in force per unit area in accordance with ASTM D412-16 (ISO 37 type 2).

As used herein, “UTS” is ultimate tensile strength, measured in mPa, and indicates stress-strain elongation properties as measured in accordance with ASTM D790-17.

As used herein, “UE” is ultimate elongation, and indicates the distance, provided as a percentage, a strand of the material can be stretched before the strand breaks in accordance with ASTM D412-16 (ISO 37 type 2).

“Vapor moisture” is given as a percentage and is a measurement of the water content of a sample by weight of the total sample that indicates curing level and customer process performance.

### Thermoplastic Vulcanizate (TPV)

Relative amounts of the various components in TPV formulations are conveniently characterized based upon the amount of elastomer in the formulation, in particular in parts by weight per hundred parts by weight of rubber (phr). The elastomer component of TPVs provided herein should be capable of being vulcanized (or cured or cross-linked). Consequently, elastomers of the present disclosure may also be referred to as “vulcanizable elastomers” or “vulcanizable elastomer rubbers.”

In embodiments of the present disclosure, the process oil is partially or completely replaced by solid plasticizing resin. Although process oils are commonly utilized in TPVs, some end-uses of TPVs are incompatible with oil. For example, TPVs intended for use or contact with food and consumables, or certain medical applications and uses. In other end-uses, it is desirable to decrease the amount or proportion of oil in the TPV. Solid plasticizing resin may be compounded in TPV to reduce or eliminate the requirement for oil.

Accordingly, the TPV formulations of the present disclosure may comprise 100 parts of a vulcanizable elastomer rubber, about 25 phr to about 250 phr of a plasticizer, and 20 phr to 250 phr of a thermoplastic polymer, wherein the plasticizer comprises a solid plasticizing resin. While the full range of 25 phr to about 250 phr of a plasticizer is available for the TPV formulations, some example ranges include: about 25 phr to about 100 phr, or about 50 phr to about 150 phr, or about 100 phr to about 250 phr, or about 100 phr to about 150 phr of a plasticizer to 100 parts rubber. While the full range of 25 phr to about 250 phr of a thermoplastic polymer is available for the TPV formulations, some example ranges include: about 20 phr to about 100 phr, or about 50 phr to about 150 phr, or about 100 phr to about 250 phr, or about 100 phr to about 150 phr of a thermoplastic polymer to 100 parts rubber.

In the TPV formulations of the present disclosure, solid plasticizing resins may be used as the only plasticizer or in combination with a processing oil.

Solid plasticizing resins may be present in any amount of the plasticizer from about 0.01 wt. % to about 100 wt. %, or from about 0.01 wt. % to about 10 wt. %, or from about 5 wt. % to about 50 wt. %, or from about 25 wt. % to about 75 wt. %, or from about 50 wt. % to about 100 wt. %, or from about 50 wt. % to about 95 wt. %, or from about 75 wt. % to about 100 wt. %, from about 85 wt. % to about 100 wt. %, from about 90 wt. % to about 100 wt. %, or from about 95 wt. % to about 100 wt. %, or from about 99 wt. % to about 100 wt. % based on the total weight of the plasticizer with the balance, if any, comprising or consisting of process oil.

If present, the process oil may be present in any amount of the plasticizer from about 1 wt. % to about 99.9 wt. %, or from about 90 wt. % to about 99.9 wt. %, or from about 50 wt. % to about 95 wt. %, or from about 25 wt. % to about 75 wt. %, or from about 1 wt. % to about 50 wt. %, or from about 5 wt. % to about 50 wt. %, or from about 1 wt. % to about 25 wt. %, from about 1 wt. % to about 15 wt. %, from about 1 wt. % to about 10 wt. %, or from about 1 wt. % to about 5 wt. %, or about 1 wt. % based on the total weight of the plasticizer with the balance comprising or consisting of the solid plasticizing resins. The TPV formulations of the present disclosure may be absent process oil. The TPV formulations of the present disclosure may comprise 0 wt. % process oil.

By way of nonlimiting example, when a process oil is used as a plasticizer in TPVs intended for food contact or medical use applications, the plasticizer of the TPV may comprise process oil at 10 wt. % or less, or 5 wt. % or less, or 1 wt. % or less, or 0 wt. % based on the total weight of the plasticizer.

Suitable solid plasticizing resins may include, but are not limited to, wax, paraffinic wax, low molecular weight polypropylene, modified polypropylene, polyisobutylene, hydrogenated tackifying resin, low molecular weight ethylene-propylene copolymer, low molecular weight polyethylene, aliphatic hydrocarbon resins, cycloaliphatic hydrocarbon resins such as the ESCOREZ® series, and the like and any combination thereof. The solid plasticizing resins may act as plasticizers to reduce the viscosity of the resulting TPV compound. In the molten stage, some solid plasticizing resins have a viscosity similar to oil, which facilitates mixing of the TPV components and improves processibility (e.g., ease of extrusion).

The solid plasticizing resins may optionally be used in combination with process oils, or may be substituted for process oils. Solid plasticizing resins may be added pre-cure, post-cure, or at any point in the curing process. Further, solid plasticizing resins may be added at different time points for example both pre- and post-cure, or pre-cure and when the TPV has been partially cured, or after partial cure and then when fully cured, or at any time point(s).

If one or more process oils are present, the process oil(s) may be selected from (i) extension oil, that is oil present in an oil-extended rubber, (ii) free oil, that is oil that is added during the vulcanization process, (iii) curative-in-oil, that is oil that is used to dissolve/disperse the curative, for example, a curative-in-oil dispersion such as a phenolic resin-in-oil, and/or (iv) any combination of oils from (i), (ii), and (iii). At least a portion of the process oil in the TPV may be a low aromatic/sulfur content oil and have (i) an aromatic content of less than 5 wt. %, or less than 3.5 wt. %, or less than 1.5 wt. %, based on the weight of that portion of process oil; and (ii) a sulfur content of less than 0.03 wt. %, or less than 0.003 wt. %, based on the weight of that portion process oil. The process oils can be made by any process known in the art. Illustrative process oils are described in U.S. Patent Application Publication Nos. 2017/0022332 and 2008/0188600, the contents of each of which is incorporated herein by reference.

The TPV formulations of the present disclosure also include vulcanizable elastomer rubbers at 100 phr. When the elastomeric component consists of elastomer only, it is by definition present at 100 phr. However, elastomeric rubbers are sometimes sold with additives already included. Accordingly, such additive concentrations should be accounted for and the elastomeric component comprising elastomeric rubber and additives is present in the TPV formulation at a sufficient concentration (e.g., 100.05 phr to 250 phr) such that the elastomeric rubber itself is at 100 phr.

Examples of vulcanizable elastomer rubbers may include, but are not limited to, unsaturated non-polar elastomers, monoolefin copolymer elastomers, and the like, and any combination thereof. Monoolefin copolymer elastomers are non-polar, elastomer copolymers of two or more monoolefins (e.g., ethylene, propylene, butene-1, pentene-1, hexene-1, 4-methylpentene-1, 5-methylhexene-1, 4-ethylhexene-1, and the like), which may optionally be copolymerized with at least one polyene, usually a diene. For example, an ethylene-propylene-diene (EPDM) elastomer is a monoolefin copolymer elastomer of ethylene, propylene, and one or more non-conjugated diene(s). Such monomer components may be polymerized using Ziegler-Natta, metallocene, or other organometallic compound catalysts. In the event that the copolymer is prepared from ethylene, alpha-olefin, and diene monomers, the copolymer may be referred to as a terpolymer or even a tetrapolymer in the event that multiple olefins or dienes are used.

Satisfactory non-conjugated dienes include 5-ethylidene-2-norbornene (ENB); 1,4-hexadiene (HD); 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; dicyclopentadiene (DCPD); 5-vinyl-2-norbornene (referred to as VNB or EP(VNB)DM); divinylbenzene, and the like, or combinations thereof. Such vulcanizable elastomer rubbers have the ability to produce thermoplastic vulcanizates with a cure state generally in excess of about 95 percent while maintaining physical properties attributable to the crystalline or semi-crystalline polymer. EP elastomer and EPDM elastomer with intrinsic viscosity (11) measured in decalin at 135° C. from about 0.1 dL/gram to about 10 dL/gram may be included. Optionally, the vulcanizable elastomer rubbers comprises EPDM.

The vulcanizable elastomer rubbers may contain from about 20 mole percent to about 90 mole percent, or from about 40 mole percent to about 85 mole percent, or from about 50 mole percent to about 80 mole percent, ethylene units derived from ethylene monomer. Furthermore, where the copolymers contain diene units, the diene units can be present in an amount from about 0.1 mole percent to about 5 mole percent, or from about 0.1 mole percent to about 4 mole percent, or from about 0.15 mole percent to about 2.5 mole percent. The balance of the copolymer will generally be made up of units derived from alpha-olefin monomers. Accordingly, the copolymer may contain from about 10 mole percent to about 80 mole percent, or from about 15 mole percent to about 50 mole percent, or from about 20 mole percent to about 40 mole percent alpha-olefin units derived from alpha-olefin monomers. The foregoing mole percentages are based upon the total moles of the polymer.

The elastomer component may comprise any one or more other suitable elastomeric copolymer capable of being at least partially vulcanized, such as butyl elastomers, natural rubbers, and any other elastomer (synthetic or natural) suitable for inclusion in a TPV, including those disclosed in U.S. Pat. Nos. 7,935,763 and 8,653,197, the entirety of each of which is hereby incorporated by reference.

Elastomers, especially those in the high end of the molecular weight range, are often oil extended in the manufacturing process and can be directly processed as such in accordance with the present disclosure. For example, an elastomer component included in a TPV may comprise both elastomer and extender oil.

Optionally, the elastomer may include one or more ethylene-propylene rubbers (“EP rubbers”). Also optionally, the EP rubber may include one or more diene-based monomers. For instance, the EP rubber may be an EPDM terpolymer.

The EP rubber may include ethylene-based units in an amount from about 45 wt. % to about 85 wt. %, by weight of the EP rubber.

The EP rubber may have diene content (e.g., amount of diene-derived comonomers) within the range of about 0 wt. % to about 10.0 wt. %, by weight of the EP rubber. In particular, the diene content may be from about 0.0 wt. % to about 10.0 wt. %, by weight of the EP rubber, provided the upper limit is greater than or equal to the lower limit.

The EP rubber may have a density within the range of about 0.850 g/cm³ to about 0.885 g/cm³, or from about 0.860 g/cm³ to about 0.880 g/cm³. In addition, EP rubbers may have a MI within the range of about 0.05 g/10 min to about 1.1 g/10 min, or about 0.1 g/10 min to about 1.0 g/10 min.

The TPV formulations of the present disclosure also include thermoplastic resins.

Any thermoplastic resin suitable for use in the manufacture of thermoplastic vulcanizates can be employed as the thermoplastic resin, including amorphous, crystalline, or semi-crystalline thermoplastics. In general, any thermoplastic described in U.S. Pat. No. 7,935,763, previously incorporated by reference herein, is suitable.

TPV formulations may include the thermoplastic resin in an amount from about 20 phr to about 250 phr, or from about 30 phr to about 250 phr, or from about 50 phr to about 250 phr, or from about 100 phr to about 150 phr. Increasing amounts of thermoplastic resin may correspond to increasing hardness of the dynamically vulcanized TPV.

The thermoplastic resin may comprise one or more crystallizable polyolefins that are formed by polymerizing alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. For example, known ethylene-based homo- and co-polymers having ethylene crystallinity are suitable. Commercial products include high density polyethylene (HDPE), linear low density polyethylene (LLDPE), and very low density polyethylene (VLDPE, or plastomers). Propylene-based homopolymers and copolymers, such as isotactic polypropylene and crystallizable copolymers of propylene and ethylene or other C4-C10 alpha-olefins, or diolefins, having isotactic propylene crystallinity, may be used. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof are also suitable. These will include reactor polypropylene copolymers and impact polypropylene copolymers, whether block, random or of mixed polymer synthesis.

The crystalline or semi-crystalline thermoplastics generally have a Tm of from about 40° C. to about 350° C. In particular examples, the Tm is within the range from about 40° C. to about 350° C.; from about 75° C. to about 210° C.; from about 85° C. to about 180° C.; from about 90° C. to about 180° C.; or from about 120° C. to about 170° C. The glass transition temperature (Tg) of these thermoplastics is from about −25° C. to about 10° C., or from about −5° C. to about 5° C. Including the semi-crystalline and glassy polar thermoplastics, useful thermoplastics will often have a Tg of up to and greater than 100° C., and even greater than 150° C.

A thermoplastic as disclosed may comprise highly crystalline isotactic or syndiotactic polypropylene. This polypropylene generally has a density of from about 0.85 g/cm³ to about 0.91 g/cm³, with the largely isotactic polypropylene having a density of from about 0.90 g/cm³ to about 0.91 g/cm³. Also, high and ultra-high molecular weight polypropylene that has a fractional melt flow rate may be used. These polypropylene resins are characterized by an MI that is from 0.2 g/10 min to 3000 g/10 min, or less than 1.2 g/10 min, or less than or equal to 0.8 g/10 min per ASTM D-1238-13. Melt flow rate is a measure of how easily a polymer flows under standard pressure, and is measured by using ASTM D-1238-13 at 230° C. and 2.16 kg load.

The thermoplastic resin may furthermore contain additional components, such as any of those additional components described in U.S. Pat. No. 7,935,763 in connection with the thermoplastic resin. For instance, the thermoplastic resin may include additional non-crosslinkable elastomers, including non-TPV thermoplastics and thermoplastic elastomers. Examples include polyolefins such as polyethylene homopolymers, and copolymers with one or more C₃-C₈ alpha-olefins.

TPV formulations may be produced using masterbatch to incorporate additives into the TPV formulation. A masterbatch (described further below) comprises a carrier resin and one or more additional components (additives like carbon black and/or antioxidants). Such masterbatches can be included in the TPV formulations of the present disclosure in an amount ranging from about 3 phr to about 350 phr, or from about 3 phr to about 50 phr, or from about 25 phr to about 100 phr, or from about 50 phr to about 350 phr, or from about 55 phr to about 200 phr, or from about 150 phr to about 350 phr. Where multiple additives (particulate and/or otherwise) are included in the masterbatch. The masterbatch may be present in the TPV formulation in higher amounts, such as from about 55 to about 350 phr, or from about 55 phr to about 200 phr, or from about 150 phr to about 350 phr.

The thermoplastic vulcanizate formulations may optionally further comprise one or more additives in addition to the masterbatch. Suitable additional TPV additives include, but are not limited to, antioxidants, fillers, processing aids, acid scavengers, and/or the like.

A TPV formulation may also include a polymeric processing additive. The processing additive employed may be a polymeric resin that has a very high melt flow index. These polymeric resins include both linear and branched molecules that have a melt flow rate that is greater than about 500 g/10 min, or greater than about 750 g/10 min, or greater than about 1000 g/10 min, or greater than about 1200 g/10 min, or greater than about 1500 g/10 min. The thermoplastic elastomers of the present disclosure may include mixtures of various branched or various linear polymeric processing additives, as well as mixtures of both linear and branched polymeric processing additives. Reference to polymeric processing additives will include both linear and branched additives unless otherwise specified. The linear polymeric processing additives may be polypropylene homopolymers. The branched polymeric processing additives may include diene-modified polypropylene polymers. Thermoplastic vulcanizates that include similar processing additives are disclosed in U.S. Pat. No. 6,451,915, which is incorporated herein by reference.

In addition, the TPV formulation may also or instead include reinforcing and non-reinforcing fillers, lubricants, antiblocking agents, anti-static agents, waxes, foaming agents, pigments, flame retardants, and other processing aids known in the rubber compounding art. These additives can comprise up to about 50 wt. % of the total composition. Fillers and extenders that can be utilized include conventional inorganics such as calcium carbonate, clays, silica, talc, titanium dioxide, as well as organic and inorganic nanoscopic fillers. Fillers may be added in masterbatch form, in combination with a carrier resin such as polypropylene.

Additional TPV additives may be added in their own separate additional masterbatch(es) (e.g., with one or more additional TPV additives per such additional masterbatch). Each additional masterbatch may comprise a carrier resin according to the carrier resin of any of the masterbatches discussed above, and/or a masterbatch may comprise a conventional carrier resin.

The TPV formulation may include acid scavengers. These acid scavengers may be added to the thermoplastic vulcanizates after the desired level of cure has been achieved. The acid scavengers are added after dynamic vulcanization. Useful acid scavengers include hydrotalcites. Both synthetic and natural hydrotalcites can be used. An exemplary natural hydrotalcite can be represented by the formula Mg₆Al₂(OH)₁₆CO₃. 4H₂O. Synthetic hydrotalcite compounds, which are believed to have the formula: Mg_{4.3}Al₂(OH)_{12.6}CO_{3.m}H₂O or Mg_{4.5}Al₂(OH)₁₃CO₃.3.5H₂O, can be obtained under the tradenames DHT-4A® or KYOWAAD™ 1000 (polymer addition agents, available from Kyowa). Another commercial example is that available under the trade name ALCAMIZER® (halogen polymer stabilizer, available from Kyowa).

### Method of Processing TPV Formulations

The thermoplastic vulcanizates may be prepared by processing of the TPV formulation, which processing may include dynamic vulcanization. Dynamic vulcanization refers to a vulcanization (cross-linking or curing) process for an elastomer contained in a blend that includes the elastomer, curatives, and at least one thermoplastic resin. The elastomer is vulcanized under conditions of shear and extension at a temperature at or above the melting point of the thermoplastic resin. The elastomer is thus simultaneously crosslinked and dispersed (optionally as fine particles) within the thermoplastic resin matrix, although other morphologies, such as co-continuous morphologies, may exist depending on the degree of cure, the elastomer to plastic viscosity ratio, the intensity of mixing, the residence time, and the temperature.

Solid plasticizing resins may be added pre-vulcanization, post-vulcanization, or at another point in the vulcanization process, or at one or more points in the vulcanization process, such as both pre- and post-cure.

Processing may include melt blending, in a blender, a TPV formulation comprising the elastomer component, thermoplastic resin, and masterbatch. The blender may be any vessel that is suitable for blending the selected composition under temperature and shearing force conditions necessary to form a thermoplastic vulcanizate. In this respect, the blender may be a mixer, such as a BANBURY® mixer, or a mill, or an extruder. The blender may be an extruder, which may be a single or multi-screw extruder. The term “multi-screw extruder” means an extruder having two or more screws; with two and three screw extruders being exemplary, and two or twin screw extruders being optionally used. The screws of the extruder may have a plurality of lobes; two and three lobe screws being optionally used. It will readily be understood that other screw designs may be selected in accordance with the methods of the present disclosure. Dynamic vulcanization may occur during and/or as a result of extrusion.

The dynamic vulcanization of the elastomer may be carried out so as to achieve relatively high shear as defined in U.S. Pat. No. 4,594,390, which is incorporated herein by reference. The mixing intensity and residence time experienced by the ingredients during dynamic vulcanization may be greater than that proposed in U.S. Pat. No. 4,594,390. The blending may be performed at a temperature not exceeding about 400° C., or not exceeding about 300° C., or not exceeding about 250° C. The minimum temperature at which the melt blending is performed is generally higher than or equal to about 130° C., or higher than or equal to about 150° C. or higher than about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization may include phase inversion. As those skilled in the art appreciate, dynamic vulcanization may begin by including a greater volume fraction of rubber than thermoplastic resin. As such, the thermoplastic resin may be present as the discontinuous phase when the rubber volume fraction is greater than that of the volume fraction of the thermoplastic resin. As dynamic vulcanization proceeds, the viscosity of the rubber increases and phase inversion occurs under dynamic mixing. In other words, upon phase inversion, the thermoplastic resin phase becomes the continuous phase.

Masterbatch, solid plasticizing resin, and any other additive(s) may be present within the TPV formulation when dynamic vulcanization is carried out, although masterbatch, solid plasticizing resin and/or any one or more other additives (if any) may be added to the composition after the curing and/or phase inversion (e.g., after the dynamic vulcanization portion of processing). Masterbatch and/or other additional ingredients may be included after dynamic vulcanization by employing a variety of techniques. The masterbatch and/or other additional ingredients can be added while the thermoplastic vulcanizate remains in its molten state from the dynamic vulcanization process. For example, the additional ingredients can be added downstream of the location of dynamic vulcanization within a process that employs continuous processing equipment, such as a single or twin screw extruder. The thermoplastic vulcanizate can be “worked-up” or pelletized, subsequently melted, and the additional ingredients can be added to the molten thermoplastic vulcanizate product. This latter process may be referred to as a “second pass” addition of the ingredients.

The TPV in molten form may be passed through a screen pack comprising one or more mesh screens at any point after dynamic vulcanization. The screen pack may comprise a 200 Standard U.S. Mesh screen (a mesh screen having 200 openings as measured across one linear inch of the mesh), or a finer screen (a screen having a larger number of openings in one inch than a 200 mesh screen, such as a 230, 270, 325, or 400 U.S. Mesh screen). The screen pack may comprise a 120, 140, 170, or finer U.S. Mesh screen. The screen pack may comprise multiple screens. For instance, the screen pack may comprise three screens in series: an inner mesh screen that is the most refined screen sandwiched between two supporting screens (e.g., via edge welding or other conventional means of forming a screen pack). For example, the screen pack may be a 20/200/20 pack (referencing a 200 U.S. Mesh screen sandwiched between two 20 U.S. Mesh screens). The screen pack may include 5, or more than 5, screens in series, such as a 10/20/200/20/10 screen arrangement (with the numbers again referencing U.S. Mesh sizes). In general, the center-most screen may be the most refined screen in the screen pack, surrounded by 2 or more supporting screens in series. The supporting screens may be any suitable mesh size that is less refined than the center screen (e.g., from 20, 25, 30, 35, 40, 45, 50, 60, 70, 80, 100, etc. U.S. Mesh). Mesh sizes in a screen may equivalently be represented in microns, where the number of microns indicates the width or length of an approximately square opening in the screen. Thus, a 200 U.S. Mesh screen (having 200 openings as measured across one linear inch of the mesh) is equivalent to a 74 micron screen (meaning each approximately square opening has length and width of 74 microns).

The TPV may be passed through the screen pack directly after dynamic vulcanization, or the TPV may be passed through the screen pack at any other point in which is the composition is in a molten state (e.g., during a second pass addition of other ingredients). Advantageously, passing the TPV through such a screen pack may enhance surface smoothness of the resulting TPV after extrusion or other processing.

Despite the fact that the elastomer may be partially or fully cured, the compositions of this disclosure can be processed and reprocessed by conventional plastic processing techniques such as extrusion, injection molding, and compression molding. The rubber within these thermoplastic elastomers is usually in the form of finely-divided and well-dispersed particles of vulcanized or cured rubber within a continuous thermoplastic phase or matrix, although a co-continuous morphology or a phase inversion is also possible.

### Resulting Thermoplastic Vulcanizate

The resulting TPV may accordingly be characterized as comprising the compounded reaction product of the ingredients forming the TPV formulation following processing of those ingredients, wherein the processing includes dynamic vulcanization.

The TPV comprises the cured elastomer in the form of finely-divided and well-dispersed particles within the thermoplastic medium. Put another way, the TPV comprises a disperse phase (comprising the at least partially cured elastomer component) in a continuous phase (comprising the thermoplastic resin). Optionally, the elastomer particles have an average diameter that is less than 50 micrometers, or less than 30 micrometers, or less than 10 micrometers, or less than 5 micrometers or less than 1 micrometer. Optionally, at least 50%, or at least 60%, or at least 75% of the particles have an average diameter of less than 5 micrometers, or less than 2 micrometers, or less than 1 micrometer.

The elastomer in the resulting TPV is completely or fully cured. The degree of cure can be measured by determining the amount of rubber that is extractable from the thermoplastic vulcanizate by using boiling xylene as an extractant. This method is disclosed in U.S. Pat. No. 4,311,628, which is incorporated herein by reference. The rubber has a degree of cure where not more than 15 weight percent, or not more than 10 weight percent, or not more than 5 weight percent, or not more than 3 weight percent is extractable by boiling xylene as described in U.S. Pat. Nos. 5,100,947 and 5,157,081, which are incorporated herein by reference. Alternatively, the rubber has a degree of cure such that the crosslink density is at least 4×10⁻⁵, or at least 7×10⁻⁵, or at least 10×10⁻⁵ moles per milliliter of elastomer. See also “Crosslink Densities and Phase Morphologies in Dynamically Vulcanized TPEs,” by Ellul et al., 68 RUBBER CHEMISTRY AND TECHNOLOGY pp. 573-584 (1995), incorporated herein by reference.

### Masterbatch

TPV formulations made using the methods of the present disclosure may include a masterbatch comprising carbon black, a carrier resin, and, optionally, other additives.

The carbon black of the masterbatch may comprise particles of any conventional type of carbon black (e.g., acetylene black, channel black, furnace black, lamp black, thermal black) produced by incomplete combustion of petroleum products. Typical particle diameters may range from about 5 nm to about 330 nm, or from about 5 nm to about 100 nm, or from about 5 nm to about 50 nm, or from about 5 nm to about 25 nm. Carbon black particles may form aggregates ranging in size (e.g., diameter when the aggregate is approximated as a sphere) from about 90 nm to about 900 nm for smaller carbon black particle aggregates, to about 1 micron to about 400 microns for larger carbon black particle aggregates. Without being limited by theory, it is believed that the carbon black imparts UV protection, improved UV weatherability and/or improvements in color retention (preservation of black pigmentation) to a TPV. The masterbatch may contain from about 0 wt. % to about 10 wt. % carbon black.

The masterbatch carrier resin may be a conventional carrier resin or propylene- or ethylene-based copolymer. In general, the carrier resin may have (i) a density from about 0.850 g/cm³ and about 0.920 g/cm³, or from about 0.860 g/cm³ and about 0.910 g/cm³, or from about 0.850 g/cm³ to about 0.890 g/cm³, or from about 0.880 g/cm³ to about 0.920 g/cm³; and (ii) a MI from about 0.05 g/10 min to about 50 g/10 min, or from about 0.1 g/10 min to about 30 g/10 min, or from about 0.1 g/10 min to about 10 g/10 min, or from about 10 g/10 min to about 20 g/10 min, or from about 20 g/10 min to about 30 g/10 min.

Optionally, the carrier resin may consist or consist essentially of the one or more propylene- or ethylene-based copolymers according to the present disclosure. By “consist essentially of” in this context, it is meant that the carrier resin contains no polymer other than the one or more propylene- or ethylene-based copolymers in amounts sufficient to modify the properties (particularly melt index) of the carrier resin compared to a carrier resin consisting of the one or more propylene- or ethylene-based copolymers. Propylene- or ethylene-based copolymers disclosed herein may include any one or more of: a propylene-alpha-olefin copolymer; an ethylene-alpha-olefin copolymer; and an ethylene-propylene copolymer rubber.

Optionally, the carrier resin comprises or consists of a propylene-alpha-olefin copolymer which is a random copolymer having crystalline regions interrupted by non-crystalline regions. Not intended to be limited by any theory, it is believed that the non-crystalline regions may result from regions of non-crystallizable polypropylene segments and/or the inclusion of comonomer units. The crystallinity and the melting point of the propylene-alpha-olefin copolymer are reduced compared to highly isotactic polypropylene by the introduction of errors (stereo and region defects) in the insertion of propylene and/or by the presence of comonomer. The propylene-alpha-olefin copolymer comprises propylene-derived units and units derived from at least one of ethylene or a C₄-C₁₀ alpha-olefin, and optionally a diene-derived unit. The copolymer contains at least about 60 wt. % propylene-derived units by weight of the propylene-alpha-olefin copolymer. The propylene-alpha-olefin copolymer may be a propylene-alpha-olefin copolymer elastomer having limited crystallinity due to adjacent isotactic propylene units and a melting point as described herein. The propylene-alpha-olefin copolymer may be generally devoid of any substantial intermolecular heterogeneity in tacticity and comonomer composition, and also generally devoid of any substantial heterogeneity in intramolecular composition distribution.

The propylene-alpha-olefin copolymer contains from about 50 wt. % to 99 wt. % propylene-derived units, or from about 60 wt. % to about 99 wt. %, or from about 65 wt. % to about 99 wt. %, or from about 75 wt. % to about 99 wt. % propylene-derived units, based on the total weight of the propylene-alpha-olefin copolymer. The propylene-alpha-olefin copolymer may include propylene-derived units in an amount based on the weight of propylene-alpha-olefin copolymer of from about 75 wt. % to about 95 wt. %, or from about 75 wt. % to about 92.5 wt. %, or from about 82.5 wt. % to about 92.5 wt. %, or from about 82.5 wt. % to about 90 wt. %. Correspondingly, the units, or comonomers, derived from at least one of ethylene or a C₄-C₁₀ alpha-olefin may be present in an amount of about 1 wt. % to about 35 wt. %, or from about 5 wt. % to about 35 wt. %, or from about 5 wt. % to about 25 wt. %, or from about 7.5 wt. % to about 25 wt. %, or from about 7.5 wt. % to about 20 wt. %, or from about 8 wt. % to about 17.5 wt. %, or from about 10 wt. % to 17.5 wt. %, based on the total weight of the propylene-alpha-olefin copolymer.

The propylene-alpha-olefin copolymer may have a heat of fusion of about 50 J/g or less, melting point of about 100° C. or less, and crystallinity of about 2% to about 65% of isotactic polypropylene, and or an MI of less than 800 g/10 min (g/10 min). The propylene-alpha-olefin copolymer may have an MI ranging from about 10 g/10 min to about 200 g/10 min, or from about 20 g/10 min to about 100 g/10 min, or from about 15 g/10 min to about 25 g/10 min, or from about 18 g/10 min to about 22 g/10 min, or about 20 g/10 min.

The propylene-alpha-olefin copolymer may be characterized according to its melt index. The propylene-alpha-olefin copolymer may have a melt index ranging from about 1.0 g/10 min to about 50.0 g/10 min, or from about 1.0 g/10 min to about 5 g/10 min, or from about 5 g/10 min to about 9 g/10 min, or from about 9 g/10 min to about 20 g/10.

The propylene-alpha-olefin copolymer may comprise more than one comonomer. The propylene-alpha-olefin copolymer may have more than one comonomer including propylene-ethylene-octene, propylene-ethylene-hexene, and propylene-ethylene-butene copolymers.

Where more than one of the comonomers derived from at least one of ethylene or a C₄-C₁₀ alpha-olefin are present, the amount of each comonomer may be less than about 5 wt. % of the propylene-alpha-olefin copolymer, but the combined amount of comonomers by weight of the propylene-alpha-olefin copolymer is about 5 wt. % or greater.

Optionally, the comonomer is ethylene, 1-hexene, or 1-octene, and may be in an amount of about 5 wt. % to about 25 wt. %, about 5 wt. % to about 20 wt. %, about 5 wt. % to about 16 wt. %, about 6 wt. % to about 18 wt. %, about 8 wt. % to about 20 wt. %, about 9 wt. % to about 13 wt. %, or about 10 wt. % to about 12 wt. % based on the weight of the propylene-alpha-olefin copolymer. Correspondingly, the propylene-alpha-olefin copolymer may comprise about 75 wt. % to about 95 wt. %, about 80 wt. % to about 95 wt. %, about 84 wt. % to about 95 wt. %, about 82 wt. % to about 94 wt. %, about 80 wt. % to about 92 wt. %, about 87 wt. % to about 91 wt. %, or about 88 wt. % to about 90 wt. % propylene-derived units.

The propylene-alpha-olefin copolymer comprises ethylene-derived units. The propylene-alpha-olefin copolymer may comprise about 5 wt. % to about 35 wt. %, or about 5 wt. % to about 25 wt. %, about 7.5 wt. % to about 20 wt. %, about 9 wt. % to about 13 wt. %, about 10 wt. % to about 12 wt. %, or about 10 wt. % to about 17.5 wt. %, of ethylene-derived units by weight of the propylene-alpha-olefin copolymer. The propylene-alpha-olefin copolymer may consist essentially of units derived from propylene and ethylene, in other words the propylene-alpha-olefin copolymer does not contain any other comonomer in an amount typically present as impurities in the ethylene and/or propylene feedstreams used during polymerization or an amount that would materially affect the heat of fusion, melting point, crystallinity, or melt flow rate of the propylene-alpha-olefin copolymer, or any other comonomer intentionally added to the polymerization process. The propylene-ethylene copolymer may consequently comprise the balance propylene-derived units in addition to ethylene-derived units in from the above-listed ranges.

The diene comonomer units may be included in the propylene-alpha-olefin at copolymer. Examples of the diene include, but not limited to, 5-ethylidene-2-norbornene, 5-vinyl-2-norbornene, divinyl benzene, 1, 4-hexadiene, 5-methylene-2-norbornene, 1, 6-octadiene, 5-methyl-1, 4-hexadiene, 3, 7-dimethyl-1, 6-octadiene, 1, 3-cyclopentadiene, 1, 4-cyclohexadiene, dicyclopentadiene, or a combination thereof. The amount of diene comonomer is equal to or more than 0 wt. %, or 0.5 wt. %, or 1 wt. %, or 1.5 wt. % and lower than, or equal to, 5 wt. %, or 4 wt. %, or 3 wt. % or 2 wt. % based on the weight of propylene-alpha-olefin copolymer.

The propylene-alpha-olefin copolymer has a heat of fusion from about 50 J/g to about 20 J/g. Suitable propylene-alpha-olefin copolymers may have a lower limit heat of fusion of from about 0.5 J/g to about 7.0 J/g.

The propylene-alpha-olefin copolymer may have a percent crystallinity, as determined according to the DSC procedure described herein, of about 2% to about 65%, or about 0.5% to about 40%, or about 1% to about 30%, or about 5% to about 35%, of isotactic polypropylene. The thermal energy for the highest order of propylene (100% crystallinity) is estimated at 189 J/g. The copolymer may have a crystallinity in the range of about 0.25% to about 25%, or about 0.5% to about 22% of isotactic polypropylene.

The propylene-derived units of the propylene-alpha-olefin copolymer have an isotactic triad fraction of about 50% to about 99%, or about 65% to about 97%, or about 75% to about 97%. The propylene-alpha-olefin copolymer has a triad tacticity as measured by ¹³C NMR of about 75% or greater, about 80% or greater, about 82% or greater, about 85% or greater, or about 90% or greater.

The propylene-alpha-olefin copolymer may have a single peak melting transition as determined by DSC. The copolymer has a primary peak transition of about 90° C. or less, with a broad end-of-melt transition of about 110° C. or greater. The copolymer may show secondary melting peaks adjacent to the principal peak, and/or at the end-of-melt transition. For the purposes of this disclosure, such secondary melting peaks are considered together as a single melting point, with the highest of these peaks being considered the Tm of the propylene-alpha-olefin copolymer. The propylene-alpha-olefin copolymer may have a Tm of about 100° C. or less, about 90° C. or less, about 80° C. or less, or about 70° C. or less. The propylene-alpha-olefin copolymer has a Tm of about 25° C. to about 100° C., about 25° C. to about 85° C., about 25° C. to about 75° C., or about 25° C. to about 65° C. The propylene-alpha-olefin copolymer has a Tm of about 30° C. to about 80° C., or about 30° C. to 70° C.

The propylene-alpha-olefin copolymer may have a Mooney viscosity [ML (1+4) @ 125° C.], as determined according to ASTM D1646-17, of less than 100, or less than 75, or less than 60, or less than 30. As used herein, Mooney viscosity is reported using the format: Rotor ([pre-heat time, min.]+[shearing time, min.] @ measurement temperature, ° C.), such that ML (1+4 @ 125° C.) indicates a Mooney viscosity determined using the ML or large rotor according to ASTM D1646-99, for a pre-heat time of 1 minute and a shear time of 4 minutes, at a temperature of 125° C. Unless otherwise specified, Mooney viscosity is reported herein as ML(1+4 @ 125° C.) in Mooney units according to ASTM D1646-17.

The propylene-alpha-olefin copolymer may have a density of about 0.850 g/cm³ to about 0.920 g/cm³, about 0.860 g/cm³ to about 0.900 g/cm³, or about 0.860 g/cm³ to about 0.890 g/cm³, at 25° C. as measured per ASTM D-1505-18.

The propylene-alpha-olefin copolymer may have a weight average molecular weight (“Mw”) of about 5,000 g/mole to about 5,000,000 g/mole, or about 10,000 g/mole to about 1,000,000 g/mole, or about 50,000 g/mole to about 400,000 g/mole; a number average molecular weight (“Mn”) of about 2,500 g/mole to about 2,500,00 g/mole, or about 10,000 g/mole to about 250,000 g/mole, or about 25,000 g/mole to about 200,000 g/mole; and/or a z-average molecular weight (“Mz”) of about 10,000 g/mole to about 7,000,000 g/mole, or about 80,000 g/mole to about 700,000 g/mole, or about 100,000 g/mole to about 500,000 g/mole. The propylene-alpha-olefin copolymer may have a molecular weight distribution (“MWD”) of about 1.5 to about 20, or about 1.5 to about 15, or about 1.5 to about 5, or about 1.8 to about 5, or about 1.8 to about 4.

The propylene-alpha-olefin copolymer may have an Elongation at Break of less than about 2000%, less than about 1000%, or less than about 800%, as measured per ASTM D412-16.

Processes suitable for preparing the propylene-alpha-olefin copolymer may include metallocene-catalyzed or Ziegler-Natta catalyzed processes, including solution, gas-phase, slurry, and/or fluidized bed polymerization reactions. Suitable polymerization processes are described in, for example, U.S. Pat. Nos. 4,543,399; 4,588,790; 5,001,205; 5,028,670; 5,317,036; 5,352,749; 5,405,922; 5,436,304; 5,453,471; 5,462,999; 5,616,661; 5,627,242; 5,665,818; 5,668,228; and 5,677,375; PCT publications WO 96/33227 and WO 97/22639; and European publications EP-A-0 794 200, EP-A-0 802 202 and EP-B-634 421, the entire contents of which are incorporated herein by reference.

The carrier resin may include, or consist of, one or more ethylene-alpha-olefin copolymers. Suitable alpha-olefin comonomers include any one or more of a C₃ to C₁₀ alpha-olefin-based monomer. The alpha-olefin is one or both of butene and octene (e.g., ethylene-butene and/or ethylene-octene copolymers).

The ethylene-alpha-olefin copolymer includes ethylene-based units in an amount greater than or equal to from about 60 wt. % to about 99 wt. %, by weight of the ethylene-alpha-olefin copolymer. The comonomer is present in an amount from about 1 wt. % to about 40 wt. %, by weight of the ethylene-alpha-olefin copolymer, provided that the upper limit is greater than or equal to the lower limit.

The ethylene-alpha-olefin copolymer may have a density of about 0.850 g/cm³ to about 0.920 g/cm³. The ethylene-alpha-olefin copolymer has a density within the range of about 0.865 g/cm³ to about 0.910 g/cm³, or from about 0.8675 g/cm³ to about 0.910 g/cm³. The ethylene-alpha-olefin copolymer may have a density within the range of from about 0.850 g/cm³ to about 0.920 g/cm³. Densities are determined in a manner consistent with ASTM D-1505-18, at 25° C., as with all other recited densities herein.

In addition, the ethylene-alpha-olefin copolymers may have a melt index within the range of about 0.4 g/10 min to about 40 g/10 min, or from about 0.5 g/10 min to about 30 g/10 min. Melt index of an ethylene-alpha-olefin copolymer may be from about 0.4 g/10 min to about 40 g/10 min.

An ethylene-alpha-olefin may be an ethylene-octene copolymer having both a density falling within the range of about 0.865 g/cm³ to about 0.900 g/cm³, and a MI falling within the range of about 0.5 g/10 min to about 4.0 g/10 min. The ethylene-alpha-olefin copolymer may alternatively be an ethylene-butene and/or an ethylene-hexene copolymer having both a density falling within the range of about 0.870 g/cm³ to about 0.910 g/cm³, and a MI falling within the range of about 1.0 g/10 min to about 30.0 g/10 min. The ethylene-alpha-olefin copolymer may also be an ethylene-octene copolymer having both a density falling within the range of about 0.880 g/cm³ to about 0.910 g/cm³ and a MI falling within the range of about 1.0 g/10 min to about 30.0 g/10 min.

Examples of suitable ethylene-alpha-olefin copolymers include EXACT™ ethylene-based copolymers (available from ExxonMobil Corp.), including EXACT™ ethylene-butene copolymers and EXACT™ ethylene-octene copolymers.

The carrier resin may include one or more ethylene-propylene rubbers (“EP rubbers”). Optionally, the EP rubber may include one or more diene-based monomers. For instance, the EP rubber may be an EPDM terpolymer.

The EP rubber may include ethylene-based units in an amount from about 45 wt. % to about 85 wt. %, by weight of the EP rubber.

The EP rubber may have diene content (e.g., amount of diene-derived comonomers) within the range of about 0 wt. % to about 10.0 wt. %, by weight of the EP rubber. The diene content may be from about 0.0, wt. %, to about 10.0 wt. %, by weight of the EP rubber.

The EP rubber may have a density within the range of about 0.850 g/cm³ to about 0.885 g/cm³, or from about 0.860 g/cm³ to about 0.880 g/cm³. In addition, EP rubbers may have a MI within the range of about 0.05 g/10 min to about 1.1 g/10 min, or about 0.1 g/10 min to about 1.0 g/10 min.

Optionally, the masterbatch may also comprise one or more other additives dispersed within the carrier resin. Again, particular examples include antioxidants, fillers, extenders, pigmentation agents, and the like (e.g., conventional inorganics such as calcium carbonate, clays, silica, talc, titanium dioxide, as well as organic and inorganic nanoscopic filler). Additives may comprise from about 0 wt. % to about 20 wt. %, or from about 0 wt. % to about 10 wt. %, or preferably from about 0 wt. % to about 5 wt. % of the masterbatch.

### Method of Masterbatch Formation

Returning now to the masterbatch, it may be formed by any suitable method for blending one or more additives (e.g., carbon black) particles with, and dispersing such particles in, a carrier resin. For instance, the additive particles and carrier resin may be dry blended and the mixture subsequently melt-mixed at a temperature above the melting temperature of the carrier resin, either directly in an extruder used to make the finished article, or by pre-melt mixing in a separate mixer (for example, a BANBURY® mixer). Dry blends of the masterbatch can also be directly injection molded without pre-melt mixture. Examples of machinery capable of generating the shear and mixing include extruders with kneaders or mixing elements with one or more mixing tips or flights, extruders with one or more screws, extruders of co- or counter-rotating type, a COPERION® ZSK twin-screw extruder (available from Coperion Corporation), a BANBURY® mixer, a FCM® Farrell Continuous Mixer (both available from Farrel Corporation, Ansonia Conn.), a BUSS Kneader™ (available from Buss, Inc. USA of Carol Stream, Ill.), and the like. The type and intensity of mixing, temperature, and residence time required can be achieved by the choice of one of the above machines in combination with the selection of kneading or mixing elements, screw design, and screw speed (<3000 rpm). Typically the temperature for melt-mixing is from about 60° C. to about 130° C., and the residence time is from about 10 minutes to about 20 minutes.

Once melt-mixed or otherwise melt-blended, the masterbatch comprising the carrier resin and optional additive particles may be pelletized by any suitable means, such as strand pelletization or the like. Underwater pelletization (e.g., extruding molten masterbatch into a water bath maintained at a temperature substantially lower than that of the molten extrudate, and pelletizing the masterbatch) may be particularly suited to pelletizing the masterbatch, owing at least in part to the carrier resin propylene-alpha-olefin copolymer's nature. Underwater pelletizing of the masterbatch may be carried out according to the techniques taught in U.S. Pat. No. 8,709,315, the entirety of which is incorporated by reference herein.

The masterbatch may be blended and formed such that the carbon black and, optionally, other additive particles are well-dispersed within the carrier resin, and are substantially non-agglomerated therein.

The masterbatch further comprises one or more additional components (besides the one or more filler, pigmentation, extender, or other additives such as carbon black), such as any one or more of processing aids (e.g., slip agents), and the like. Any additive suitable for inclusion in a TPV (particulate or not) may be incorporated into the masterbatch.

### Example Embodiments

A first example embodiment is a thermoplastic vulcanizate (TPV) composition comprising 100 parts of a vulcanizable elastomer rubber; 20 parts per hundred parts by weight of the rubber (phr) to 250 phr of a thermoplastic polymer; and 25 phr to 250 phr of a plasticizer; wherein the plasticizer comprises a solid plasticizing resin.

The first example embodiment can include one or more of the following: Element 1: wherein the solid plasticizing resin comprises a cycloaliphatic hydrocarbon resin; Element 2: wherein the solid plasticizing resin is selected from the list consisting of wax, paraffinic wax, low molecular weight polypropylene, modified polypropylene, polyisobutylene, hydrogenated tackifying resin, low molecular weight ethylene-propylene copolymer, low molecular weight polyethylene, or aliphatic hydrocarbon resins; Element 3: wherein the plasticizer further comprises process oil at less than 20 wt. % of the plasticizer; Element 4: wherein the plasticizer is absent process oil; Element 5: wherein the vulcanizable elastomer rubber is selected from the group consisting of elastomeric polyolefin copolymers, butyl rubber, natural rubber, styrene-butadiene copolymer rubber, butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene; Element 6: wherein the composition further comprises 1 phr to 250 phr of a filler; and Element 7: wherein the thermoplastic resin is selected from the group consisting of polyethylene, polypropylene, ethylene alpha-olefin copolymers, polypropylene random copolymer, and propylene-based elastomers.

Examples of combinations include, but are not limited to, Element 1 in combination with one or more of claims 3-7; Element 2 in combination with one or more of Elements 3-7; Element 3 in combination with one or more of combinations 5-7; Element 4 in combination with one or more of Elements 5-7; Element 5 in combination with one or more of Elements 6-7; and Element 6 in combination with Element 7.

A second example embodiment is a method comprising introducing to a blender each of a masterbatch comprising a first thermoplastic polymer and a curative; 100 parts of a vulcanizable elastomer rubber; a second thermoplastic polymer, wherein the first and second thermoplastic polymers combined are 20 phr to 250 phr; 25 phr to 250 phr of a plasticizer, wherein the plasticizer comprises a solid plasticizing resin; and dynamically vulcanizing at least a portion of the vulcanizable elastomer rubber so as to form a thermoplastic vulcanizate.

The second example embodiment can include one or more of the following: Element 8: wherein the plasticizer consists of the solid plasticizing resin; Element 9: wherein the vulcanizable elastomer rubber is selected from the group consisting of elastomeric polyolefin copolymers, butyl rubber, natural rubber, styrene-butadiene copolymer rubber, butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlolorohydrin terpolymer rubber, and polychloroprene; Element 10: wherein the blender is selected from the group consisting of a mixer, a mill, and an extruder; Element 11: wherein the plasticizer further comprises process oil; Element 12: wherein the plasticizer further comprises process oil at less than 20 wt. % of the plasticizer; Element 13: wherein the plasticizer is absent process oil; and Element 14: further comprising introducing to the blender one or more additives selected from the group consisting of fillers, processing aids, acid scavengers, and any combination thereof.

Examples of combinations include, but are not limited to, Element 8 in combination with one or more of Elements 9-10, and 13-14; Element 9 in combination with one or more of Elements 10-14; Element 10 in combination with one or more of Elements 11-14; Element 11 in combination with one or more of Elements 12 and 14; Element 12 in combination with Element 14; and Element 13 in combination with Element 14.

A third example embodiment is a method comprising introducing to a blender each of a masterbatch comprising a first thermoplastic polymer and a curative; 100 parts of a vulcanizable elastomer rubber; a second thermoplastic polymer, wherein the first and second thermoplastic polymers combined are 20 phr to 250 phr; and performing the steps of at least partially the vulcanizable elastomer rubber; and introducing to the blender 25 phr to 250 phr of a plasticizer, wherein the plasticizer comprises a solid plasticizing resin.

The third example embodiment can include one or more of the following: Element 15: wherein the 25 phr to 250 phr of a plasticizer is introduced into the blender after at least partially dynamically vulcanizing the vulcanizable elastomer rubber; Element 16: wherein the 25 phr to 250 phr of a plasticizer is introduced into the blender before dynamic vulcanization of the masterbatch and thermoplastic resin in at least a portion of the vulcanizable elastomer; Element 17: wherein the plasticizer further comprises process oil at less than 20 wt. % of the plasticizer; and Element 18: wherein the plasticizer is absent process oil.

Examples of combinations include, but are not limited to, Element 15 in combination with one or more of Elements 16-18; Element 16 in combination with one or more of Elements 17-18; and Element 17 in combination with Element 18.

As used in the present “disclosure and claims, the singular forms “a,” “an,” and “the” shall include plural forms unless the context clearly dictates otherwise.

The term “and/or” as used in a phrase such as “A and/or B” herein is intended to include “A and B,” “A or B,” “A,” and “B.”

To facilitate a better understanding of the embodiments of the present invention, the following examples of preferred or representative embodiments are given. In no way should the following examples be read to limit, or to define, the scope of the invention.

### Examples

TPVs comprising the components in Table 1 were blended using a BRABENDER® processor (mixer, available from C. W. Brabender Instruments, Inc.), and properties of the resulting TPV were analyzed using methods described above. Components of the TPVs tested below (Table 1) include EXXPRO® 3745 (synthetic rubber, available from ExxonMobil Corp.), a brominated copolymer of isobutlene and paramethyl-styrene with high cure activity; PP5341 (hPP), a polypropylene homopolymer with a low melt flow rate; ICECAP-K® clay (anhydrous aluminum silicate clay, available from Burgess Pigment Company); MgO, magnesium oxide; SnCl₂ MB, or stannous chloride masterbatch; ZnO, zinc oxide; Resin SP-1045, a phenolic resin curative; INDOPOL® H100 (a processing oil, butylene polymers available from Ineos Oligomers USA LLC.); and ESCOREZ® 5320 synthetic resin (a solid plasticizing resin).

TABLE 1

| | | 1/3 | 2/3 | All |
|---|---|---|---|---|
| Formulation | Control | ESCOREZ ® | ESCOREZ ® | ESCOREZ ® |
| EXXPRO ® 3745 (phr) | 100.00 | 100.00 | 100.00 | 100.00 |
| PP5341 (hPP) (phr) | 164.00 | 164.00 | 164.00 | 164.00 |
| ICECAP-K ® clay (phr) | 10.00 | 10.00 | 10.00 | 10.00 |
| MgO (phr) | 2.00 | 2.00 | 2.00 | 2.00 |
| Stearic acid (phr) | 1.00 | 1.00 | 1.00 | 1.00 |
| SnCl₂ MB (phr) | 1.30 | 1.30 | 1.30 | 1.30 |
| ZnO (phr) | 2.00 | 2.00 | 2.00 | 2.00 |
| Resin SP-1045 (solid cure) (phr) | 3.50 | 3.50 | 3.50 | 3.50 |
| INDOPOL ® H100 (pre-cure) | 42.30 | 20.00 | — | — |
| (phr) | | | | |
| INDOPOL ® H100 (post-cure) | 22.00 | 22.00 | 22.00 | — |
| (phr) | | | | |
| ESCOREZ ® 5320 (phr) | — | 22.30 | 42.30 | 64.30 |
| Total Formulation phr | 348.10 | 348.10 | 348.10 | 348.10 |
| Thermal Conductivity (W/mK) | 0.153 | 0.154 | 0.153 | 0.155 |
| Hardness, Shore D (15 sec) | 41.7 | 43.4 | 46.6 | 53.7 |
| Swell in IRM903, 24 hrs, | 14.6 | 12.4 | 10.5 | 8.9 |
| @121° C., % wt. gain (%) | | | | |
| Specific gravity @23° C. | 0.945 | 0.955 | 0.966 | 0.978 |

TPVs comprising the components in Table 2 were blended using a twin screw at extruder, and properties of the resulting TPV were analyzed using methods described above. Components are as described above, and additionally HRJ 16261, a 70% resin in oil; and MGVEA001-MB, a masterbatch with 100 phr PP5341.

TABLE 2

| Formulation | Masterbatch | A | B |
|---|---|---|---|
| EXXPRO ® 3745 (phr) | 100.00 | — | — |
| ICECAP-K ® clay (phr) | 5.00 | 5.00 | 5.00 |
| ZnO (phr) | — | 5.00 | 5.00 |
| Resin SP-1045 (phr) | — | — | 3.50 |
| HRJ 16261 (phr) | — | 14.00 | — |
| PP5341 (phr) | 100.00 | 64.00 | 64.00 |
| ESCOREZ ® 5230 (phr) | — | — | 22.00 |
| MCVEA001-MB (phr) | — | 247.30 | 247.30 |
| INDOPOL ® H100 (phr) | 42.30 | — | — |
| INDOPOL ® H100 (phr) | — | 12.20 | — |
| Total formulation | 247.30 | 347.50 | 346.80 |

Properties of TPVs listed in Table 2 are provided below in Table 3.

TABLE 3

| Formulation | A | B |
|---|---|---|
| Vapor Moisture (%) | 0.0527 | 0.0476 |
| Ceast (LCR@1200 1/s) | 131.6 | 154.5 |
| Specific Gravity (22.7° C.) | 0.94 | 0.95 |
| Extrusion Surface Ra (μin) | 98.7 | 125.0 |
| Hardness (ISO) Shore D | 37.9 | 43.8 |
| Tensile UTS (MPa) | 18.2 | 18.5 |
| Tensile UE (%) | 497 | 518 |
| Tensile M100 | 9.5 | 10.3 |
| Advance Polymer Analyzer, (APA) | 16183.3 | 15831.9 |
| Strain 06, G′ Datapoint 01 (kPa) | | |

All documents described herein are incorporated by reference herein for purposes of all jurisdictions where such practice is allowed, including any priority documents and/or testing procedures to the extent the documents, including any priority documents and/or testing procedures, are not inconsistent with this text. As is apparent from the foregoing general at description and the specific embodiments, while forms of the disclosure have been illustrated and described, various modifications can be made without departing from the spirit and scope of the disclosure. Accordingly, Applicant does not intend that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed, including the upper and lower limit. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that the indefinite articles “a” or “an” introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

What is claimed is:

1. A thermoplastic vulcanizate (TPV) composition comprising
100 parts of a vulcanizable elastomer rubber;
20 parts per hundred parts by weight of the rubber (phr) to 250 phr of a thermoplastic polymer; and
25 phr to 250 phr of a plasticizer; wherein the plasticizer comprises a solid plasticizing resin.

2. The composition in accordance with claim 1, wherein the solid plasticizing resin comprises a cycloaliphatic hydrocarbon resin.

3. The composition in accordance with claim 1, wherein the solid plasticizing resin is selected from the list consisting of wax, paraffinic wax, low molecular weight polypropylene, modified polypropylene, polyisobutylene, hydrogenated tackifying resin, low molecular weight ethylene-propylene copolymer, low molecular weight polyethylene, or aliphatic hydrocarbon resins.

4. A composition in accordance of claim 1, wherein the plasticizer consists of the solid plasticizing resin.

5. A composition in accordance of claim 1, wherein the plasticizer further comprises process oil at less than 20 wt. % of the plasticizer based on a total weight of the plasticizer.

6. A composition in accordance of claim 1, wherein the plasticizer is absent process oil.

7. A composition in accordance of claim 1, wherein the plasticizer comprises the solid plasticizing resin at 75 wt. % to 100 wt. % based on a total weight of the plasticizer.

8. A composition in accordance with claim 1 further comprising: 1 phr to 250 phr of a filler.

9. A composition in accordance with claim 1, wherein the thermoplastic resin is selected from the group consisting of polyethylene, polypropylene, ethylene alpha-olefin copolymers, polypropylene random copolymer, and propylene-based elastomers.

10. A food contact article comprising the composition according to claim 1 wherein the plasticizer is absent process oil.

11. An article for medical use comprising the composition according to claim 1 wherein the plasticizer is absent process oil.

12. A method comprising:
introducing to a blender each of
a masterbatch comprising a first thermoplastic polymer and a curative;
100 parts of a vulcanizable elastomer rubber;
a second thermoplastic polymer, wherein the first and second thermoplastic polymers combined are 20 parts per hundred parts by weight of the rubber (phr) to 250 phr;
25 phr to 250 phr of a plasticizer, wherein the plasticizer comprises a solid plasticizing resin; and
dynamically vulcanizing at least a portion of the vulcanizable elastomer rubber so as to form a thermoplastic vulcanizate.

13. The method of claim 12, wherein the plasticizer consists of the solid plasticizing resin.

14. The method of claim 12, wherein the plasticizer comprises the solid plasticizing resin at 80 wt. % to 100 wt. % based on a total weight of the plasticizer.

15. The method of claim 12, wherein the plasticizer further comprises process oil at less than 20 wt. % of the plasticizer.

16. The method of claim 12, wherein the plasticizer is absent process oil.

17. The method of claim 12, wherein the blender is selected from the group consisting of a mixer, a mill, and an extruder.

18. The method of claim 12, further comprising introducing to the blender one or more additives selected from the group consisting of fillers, processing aids, acid scavengers, and any combination thereof.

19. A method comprising:
introducing to a blender each of
a masterbatch comprising a first thermoplastic polymer and a curative;
100 parts of a vulcanizable elastomer rubber;
a second thermoplastic polymer, wherein the first and second thermoplastic polymers combined are 20 parts per hundred parts by weight of the rubber (phr) to 250 phr; and
performing the steps of
at least partially dynamically vulcanizing the vulcanizable elastomer rubber; and
introducing to the blender 25 phr to 250 phr of a plasticizer, wherein the plasticizer comprises a solid plasticizing resin.

20. The method of claim 19, wherein the 25 phr to 250 phr of a plasticizer is introduced into the blender after at least partially dynamically vulcanizing the vulcanizable elastomer rubber.

21. The method of claim 19, wherein the 25 phr to 250 phr of a plasticizer is introduced into the blender before dynamic vulcanization of the masterbatch and thermoplastic resin in at least a portion of the vulcanizable elastomer rubber.

22. The method of claim 19, wherein the plasticizer further comprises process oil at less than 20 wt. % of the plasticizer.

23. The method of claim 19, wherein the plasticizer is absent process oil.
